(19) United States
(12) Patent Application Publication
(10) Pub. No.: US 2007/0124584 A1
(43) Pub. Date: May 31, 2007

(54) Proving ownership of shared information to a third party

(75) Inventor: Rohit Gupta, Redmond, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/290,038

(22) Filed: Nov. 30, 2005

(51) Int. Cl. H04L 9/00

(52) U.S. Cl. 713/168; 713/176; 713/180; 713/181

(57) ABSTRACT

Establishing proof of authorized receipt of information between two recipients involves a sender developing an asymmetric key pair and sending one key to each of the two recipients. A first recipient develops a challenge and sends it to the second recipient. The second recipient uses a first key to encrypt the challenge and return it to the first recipient. The first recipient decrypts the response using the second key. A correct response allows the first recipient to trust that the second recipient has an authorized copy of the information because they each have a key associated with the information that came from the sender. No prior relationship between the recipients is assumed and a public key infrastructure is not required.

### BACKGROUND

In many circumstances, it is important for an entity to prove ownership of information received. For example, Melissa may be reluctant to discuss a business forecast with Bob until Melissa is sure Bob was given the same information Melissa has. In a co-located office situation, Bob merely has to show Melissa a copy of the business forecast to prove ownership of the data. In some business environments numbered copies of sensitive data provide further proof of authorized ownership.

The problem remains the same in networked environments where physical possession of hardcopy documents may be difficult or impossible. In some security domains, such as, within a business unit, a fully developed public key infrastructure (PKI) may allow passing signed documents between participants to prove ownership. For example, Alice may send signed copies of the business forecast to both Bob and Melissa. Bob can sign his copy and forward to Melissa. Melissa can verify Bob's signature and then Alice's signature to give herself some confidence that Bob has a received a copy from Alice. However, fully developed PKI with full time access to a certificate authority and certificate revocation list may be both expensive and difficult to maintain. This is further complicated when the entities are under different security domains (e.g. use different certificate authorities). Methods exist to handle such situations, such as cross-signed root certificates, but these are particularly difficult to manage.

The situation is further complicated when applied to ad hoc networks or peer-to-peer networks that may be transient in nature and either are not part of a full PKI trust infrastructure or don't have access to such an infrastructure.

### SUMMARY

To allow proof of ownership between recipients, a sender may generate a one-time use asymmetric key pair and send one key to each recipient, along with the data of interest. When each recipient has received the data and the respective asymmetric key, the keys may be used in a challenge/response authentication process to prove to authorized ownership of the data of interest.

To help ensure the integrity of the process, additional steps may be taken with respect to proper delivery of the keys as well as the use of secure channels for message delivery.

### BRIEF DESCRIPTION OF THE DRAWINGS

FIG. 1 is a simplified and representative block diagram of a computer network;

FIG. 2 is a block diagram of a computer that may be connected to the network of FIG. 1;

FIG. 3 is block diagram showing message flow between a sender and two recipients of the data;

FIG. 4 is a flow chart of a method of preparing and sending data and related security messages to the two recipients;

FIG. 5A is a flow chart of a method of processing the data and related security message by a first recipient;

FIG. 5B is a flow chart of a method of processing the data and related security message by a second recipient;

FIG. 6 is a method for the second recipient to prove authorized receipt of the data by the first recipient; and

FIG. 7 is an alternate method for the second recipient to prove authorized receipt of the data by the first recipient.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . .” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

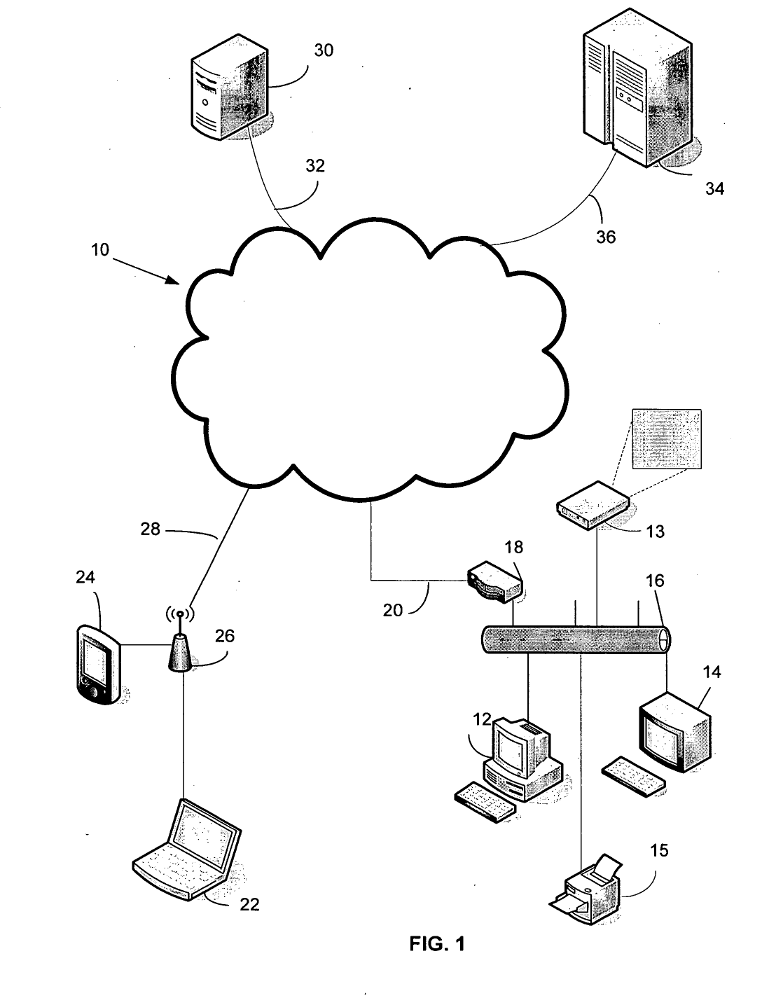

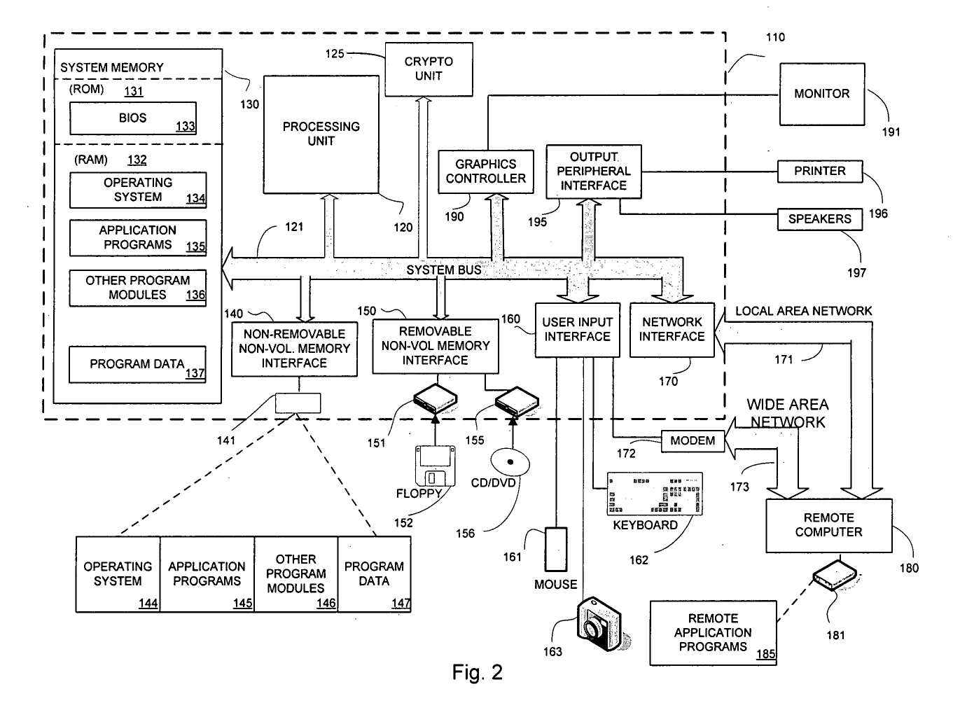

FIGS. 1 and 2 provide a structural basis for the network and computational platforms related to the instant disclosure.

FIG. 1 illustrates a network 10 that may be used to implement a dynamic software provisioning system. The network 10 may be the Internet, a virtual private network (VPN), or any other network that allows one or more computers, communication devices, databases, etc., to be communicatively connected to each other. The network 10 may be connected to a personal computer 12 and a computer terminal 14 via an Ethernet 16 and a router 18, and a landline 20. Other networked resources, such as a projector 13 and printer 15 may also be supported via the Ethernet 16 or another data network. On the other hand, the network 10 may be wirelessly connected to a laptop computer 22 and a personal data assistant 24 via a wireless communication station 26 and a wireless link 28. Similarly, a server 30 may be connected to the network 10 using a communication link 32 and a mainframe 34 may be connected to the network 10 using another communication link 36. In one embodiment, the server 30 may function as a presentation server for serving presentation data on the network 10. In another embodiment, the mainframe 34 may function as a broadcast server to make available data to a large number of users, for example, corporate financial results presentations. The network 10 may be useful for supporting peer-to-peer network traffic. It should be noted that peer-to-peer network traffic may pass through intermediate hosts, including servers, proxies, routers, switches, and other elements whose role is to facilitate the transmission of data between the communicating hosts.

FIG. 2 illustrates a computing device in the form of a computer 110. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 may also include a cryptographic unit 125. Briefly, the cryptographic unit 125 has a calculation function that may be used to verify digital signatures, calculate hashes, digitally sign hash values, and encrypt or decrypt data. The cryptographic unit 125 may also have a protected memory for storing keys and other secret data. In addition, the cryptographic unit 125 may include an RNG (random number generator) which is used to provide random numbers. In other embodiments, the functions of the cryptographic unit may be instantiated in software or firmware and may run via the operating system.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and cursor control device 161, commonly referred to as a mouse, trackball or touch pad. A camera 163 , such as web camera (webcam), may capture and input pictures of an environment associated with the computer 110, such as providing pictures of users. The webcam 163 may capture pictures on demand, for example, when instructed by a user, or may take pictures periodically under the control of the computer 110. Other input devices (not shown) may include a microphone, joystick, game pad, satellite dish, scanner, or the like. These and other input devices are often connected to the processing unit 120 through an input interface 160 that is coupled to the system bus, but may be connected by other interface and bus structures, such as a parallel port, game port or a universal serial bus (USB). A monitor 191 or other type of display device is also connected to the system bus 121 via an interface, such as a graphics controller 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181.

The communications connections 170 172 allow the device to communicate with other devices. The communications connections 170 172 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

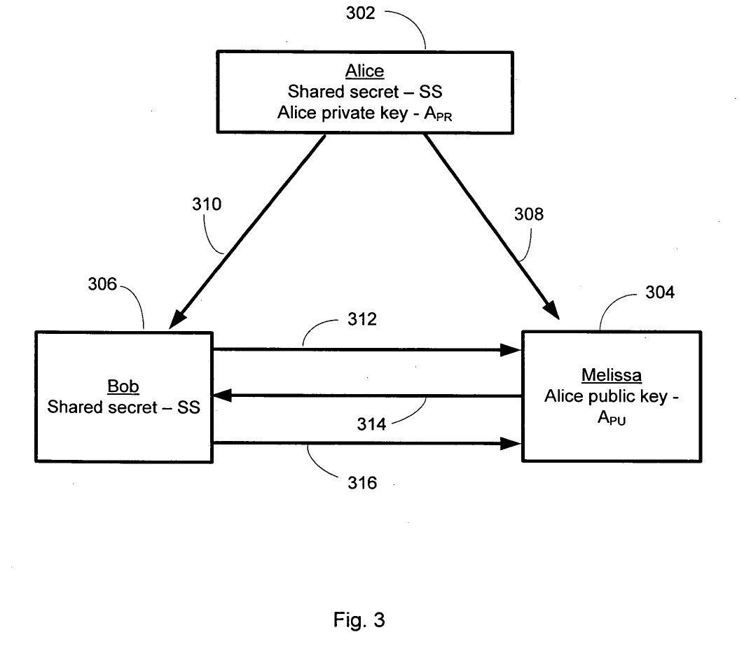

FIG. 3 is a block diagram showing message flows between a sender Alice 302, a second party Melissa 304, and a third party Bob 306. For convenience, a familiar cryptographic notion of named parties is used. Alice 302, Melissa 304, and Bob 306 may be any of the devices of FIG. 1, such as, but not limited to computer 12, laptop 22, PDA 24, or server 32. Additionally, the sender and recipients may be processes running on any of the physical devices, whereby the verification process described may be between two processes running on a single computer or between two or more computers.

Two prerequisites are shown in FIG. 3. First, Alice 302 and Bob 306 have a shared secret SS. Second, Alice 302 has a private key, A_{PR}, and Melissa 304 has a corresponding public key, A_{PU}. It is not necessary that this public/private key pair is certified by a trusted certificate authority. The public/private key pair may be generated as part of Alice's registration into a peer-to-peer network and maybe propagated as a self-signed certificate.

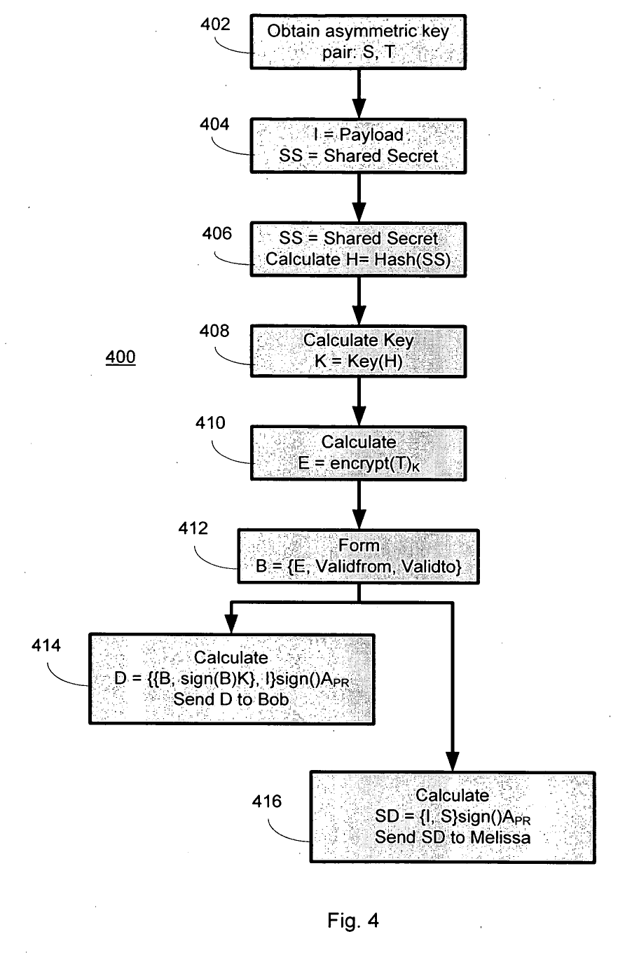

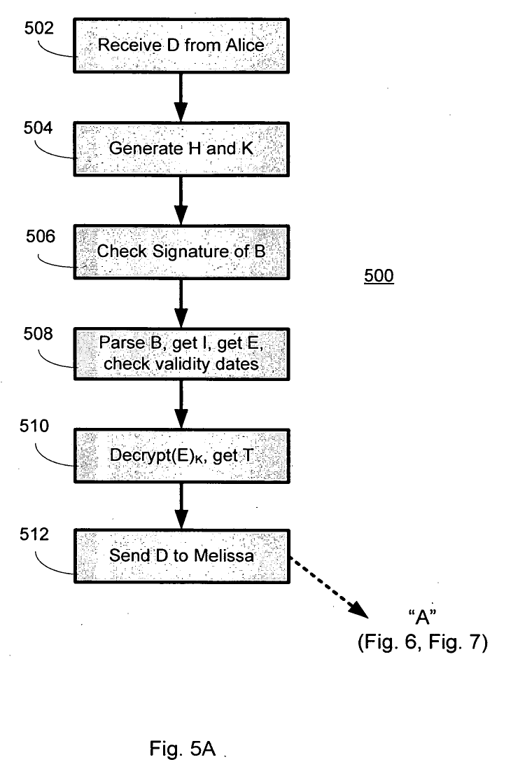

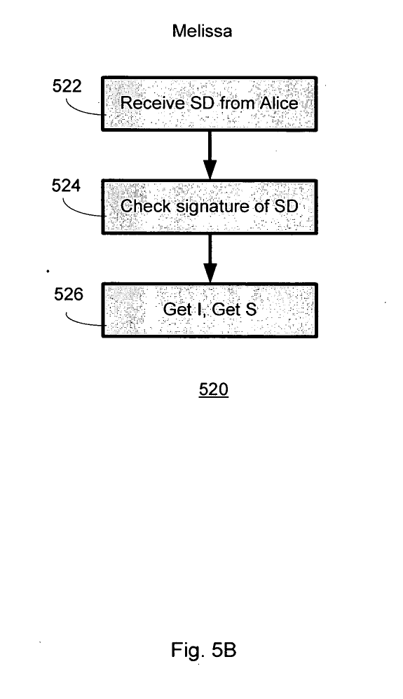

Alice 302 may prepare security messages for Bob 306 and Melissa 304 has detail below with respect to FIG. 4. When complete, Alice 302 may send the data and the security messages to Melissa 304 as shown by transmission 308. Alice 302 may also send the data and the security messages to Bob 306 as shown by transmission 310. Bob 306 may process the messages as detailed in FIG. 5A. Similarly, Melissa 304 may process the messages from Alice 302 as detailed in FIG. 5B.

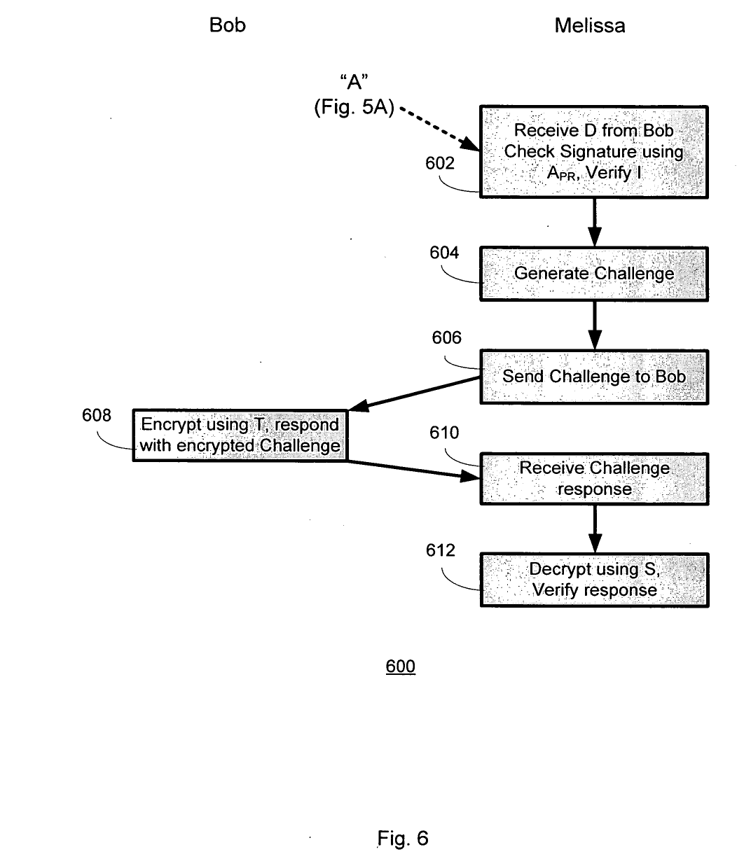

Bob 306 may then send a transmission 312 to Melissa 304 containing a portion of the data sent from Alice 302. To the transmission 312 may serve as a trigger for Melissa 304 to send a challenge to Bob 306 via transmission 314. Bob 306 may process the challenge and return response via transmission 316. Several alternatives exist for the challenge and response between Melissa 304 and Bob 306. Two such alternatives are shown in FIGS. 6 & 7.

FIG. 4 is a flow chart of a method 400 of preparing and sending data and related security messages to the two recipients. The methods described in FIGS. 4-7 reliance certain characteristics of asymmetric cryptography. To remind the reader, asymmetric cryptography takes advantage of the notion that two related keys, a key pair, operate such that a first key can encrypt data and only the second key can decrypt the data. Similarly, the second key can encrypt data that can only be decrypted using the first key. Normally, in a PKI infrastructure one key is kept secret and called a private key while the other key is distributed and called a public key. Even given this distinction, the keys are functionally equivalent and the private key has no more capability than the public key.

FIG. 4 shows one embodiment of actions that may be performed by Alice 302. At block 402 and asymmetric key pair may be generated. In one embodiment, a 1024 bit may be generated using an RSA algorithm. In another embodiment, an elliptic curve algorithm may be used to generate a 160 bit key. Both the RSA and elliptic curve algorithms are known in the industry. For the purpose of this example, the keys are designated S (second party) and T (third party). At block 404, a data payload, designated I, may be identified. At block 406 shared secret, known only to Bob 306 and Alice 302, designated SS, may be used to calculate a value H, a hash of the shared secret SS. In one embodiment, the hash function used may be a SHA-256. At block 408, a key, K, may be generated from H using a known key generation function, such as a PBKDF2 used with an HMAC-SHA-1.

The “T” asymmetric key may be encrypted with the key K, the result designated E, at block 410, E=encrypt (T)_{K}. The encryption of T using key K, may be a symmetric encryption operation such as Advanced Encryption System (AES), as is known in the industry. Alice 302 may determine a lifetime for the keys T and S and may form, at block 412, B=(E, Validfrom, Validto), the Validfrom and Validto dates or times representing the lifetime of the keys. In one embodiment, the keys are valid for one day.

At block 414, the data for Bob 306 may be prepared and sent. The complete message for Bob 306 may be designed D={{B, sign(B)_{K}}, I}sign( )A_{PR}. That is, the value B, the value B signed using the generated key K, and the data payload, I, all signed by Alice's private key A_{PR}. The message D may be transmitted to Bob 306, shown in FIG. 3 as transmission 310.

At block 416, the data for Melissa 304 may be prepared and sent. The complete message for Melissa 304 may be designed SD={I, S}sign( )A_{PR}. That is, the data payload, I, and the “S” asymmetric key are signed by Alice's private key A_{PR}.

FIG. 5A is a flow chart of a method 500 of processing the data and related security message by a first recipient, in this example, Bob 306. Bob 306 receives data D from Alice 302 at block 502. Bob 306 may then generate a key K={key{Hash(SS)}}. This is the same symmetric key generated by Alice 302 at block 408, FIG. 4. The key generation step may be performed at any time prior to the use of the key K. At block 506, using the key, K, the signature of B may be checked against the value of B. Signatures may use an ECDSA-256 algorithm, known in the art. When the signature verification passes, Bob may be sure that the value of B is un-tampered and came from Alice 302, at least to the extent the security of the shared secret SS has been maintained.

At block 508, B may be parsed into its components: E, Validfrom, and Validto. If within the validity dates, that is, after the Validfrom date/time and before the Validto date/time, the process may continue. The value of I, the data payload, may be extracted from D. E may then be decrypted using key, K, at block 510 to yield the second asymmetric key, T.

With the individual data elements available and any validity checks completed, the processing may continue at block 512 where the data message D may be sent to Melissa, for example, using message transport 312 of FIG. 3.

FIG. 5B is a flow chart of a method 520 of processing the data send from Alice 302 to Melissa 304. Melissa may receive the data SD from Alice at block 522. Melissa 304 may then check the signature of SD using Alice's public key, A_{PU}. After signature verification at block 524, the component information in SD, the data payload, I, and the asymmetric key, S, may be extracted and stored.

FIG. 6 is an exemplary method 600 for the second recipient, Bob, to prove authorized receipt of the data by the first recipient, Alice. At block 602, Melissa may receive the message D from Bob as a continuation from block 512 of FIG. 5A. Melissa may then verify the signature of D, as signed by Alice, using Alice's public key, A_{PU}. Melissa may also at this time verify the information I received from Bob is consistent with the information I received from Alice at block 416 of FIG. 4. If the two values match, Melissa knows that Bob has a copy of the data from Alice. What remains is for Melissa to receive an assurance that Bob received the information I from Alice and not from either a third party or by some form of pilfering.

Melissa may generate a challenge at block 604. As is known in the art, the challenge may be a random number or a nonce and may include a sequence number to help prevent replay attacks. The challenge may be sent to Bob at block 606. Bob may then receive the challenge at block 608 and encrypt the challenge at block 608 using the asymmetric key T. The response to the challenge may then be returned to Melissa. Melissa may, at block 610, receive the challenge response. At block 612 Melissa may decrypt the challenge response from Bob using the asymmetric key S. If the decrypted response matches the challenge generated at block 604, Melissa then has an assurance that the challenge was sent to an entity known to Alice, in this case, Bob. The assurance relies on the fact that only the T key can encrypt data readable by the S key, and because merely by possessing the T key, Melissa has a reasonable assurance that Alice gave Bob the data, I, and the key, T.

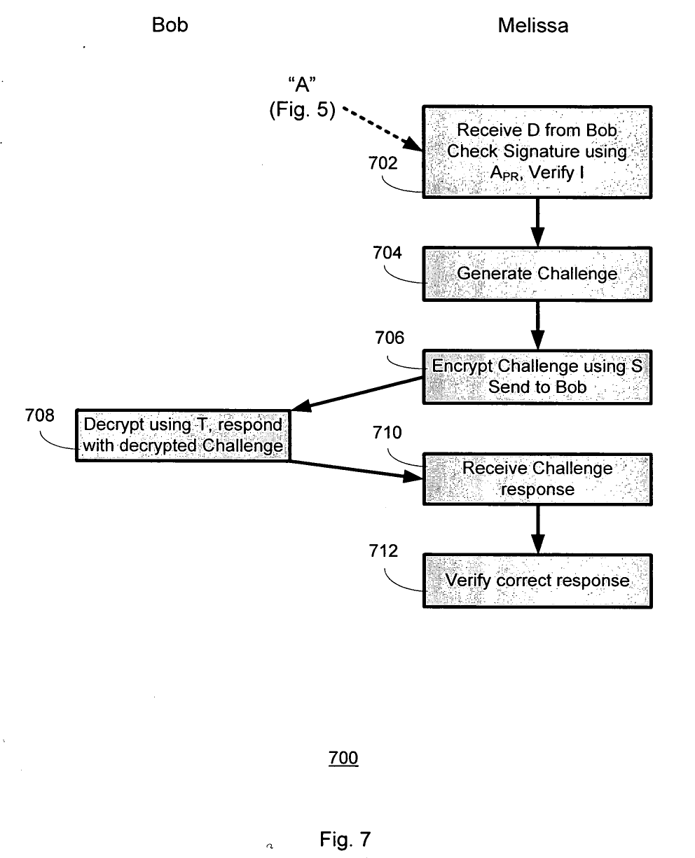

FIG. 7 is an alternate method for the second recipient, Bob to prove authorized receipt of the data by the first recipient, Alice. This is a alternative form for using the cryptographic verification process described in FIG. 6. Again, Melissa may receive the message D from Bob at block 702 and may verify the signature using Alice's public key, A_{PU}. Melissa may then generate a challenge at block 704, as above, using known cryptographic techniques such as a random number or nonce. The challenge may be encrypted by Melissa at block 706 using the asymmetric key, S, and the challenge sent to Bob.

At block 708, Bob may receive the challenge and decrypt the challenge using the asymmetric key, T, that he received from Alice. Bob may then return the decrypted challenge to Melissa. At block 710, Melissa may receive the response. Melissa may then verify, at block 712, the response by confirming the decrypted challenge received against the original challenge generated at block 704. When confirmed, Bob has proven to Melissa that he has the matching key, T, to Melissa's key, S. Melissa may then assume with some confidence that the data I, shared by Alice with Melissa was also shared with Bob. In one example, a subsequent conversation regarding the data I, may then be held between Bob and Melissa, without other authorization or interaction with Alice, with Melissa assured she is dealing with an authorized recipient of the data.

The use of asymmetric key pairs to accompany data transmissions provides users in transient or other non-trusted environments to enable verification of relationships between recipients. This may allow parties to proceed with confidence in dealing with each other absent a known or trusted source. This may provide both users and inter-process communications to share data and collaborate with confidence even in. The methods described above are easily extensible to two-way verification and one-to-many verifications.

Although the foregoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A method of proving ownership of data between recipients of data sent by a first party to each of a second and third party comprising:
obtaining at the first party an asymmetric key pair having asymmetric keys S and T;
sending the data and the S key from the first party to the second party;
sending the data and the T key from the first party to the third party;
generating a challenge at the second party;
sending a challenge from the second party to the third party;
operating on the challenge at the third party using the T key to develop a response;
sending the response to the second party; and
confirming the response at the second party.

2. The method of claim 1, wherein:
generating a challenge at the second party comprises creating an encrypted challenge using the S key;
operating on the challenge at the third party comprises decrypting the encrypted challenge using the T key at the third party; and
confirming the response comprises confirming the challenge at the second party.

3. The method of claim 1, wherein:
generating a challenge at the second party comprises sending an unencrypted challenge;
operating on the challenge at the third party comprises creating an encrypted challenge using the T key at the third party; and
confirming the response comprises decrypting the encrypted challenge at the second party and confirming a match with the unencrypted challenge.

4. The method of claim 1, further comprising:
sharing a secret between the first and third party;
encrypting the data and the T key using a form of the secret before sending the data and the T key from the first party to the third party;
decrypting the data and the T key using the form of the secret at the third party.

5. The method of claim 1, further comprising sending validity dates for the asymmetric key pair to the second and third parties.

6. The method of claim 1, further comprising sending a form of the data from the third party to the second party.

7. A computer-readable medium having computer executable instructions for use in validating authentic possession of data received by a first party implementing a method for use in validating authentic possession of data by a second party received from a first party comprising:
receiving a message comprising the data and a first key of an asymmetric key pair from the first party;
verifying a signature of the message using a public key from the first party corresponding to a private key controlled by the first party;
receiving from a third party a second message comprising a test data;
encrypting a challenge with the first key to form an encrypted challenge;
sending the encrypted challenge to the third party;
receiving a response from the third party comprising the decrypted challenge;
verifying the decrypted challenge matches the challenge; and
verifying the test data matches the data, whereby the authorized ownership of the data by the third party is confirmed.

8. The computer-readable medium of computer executable instructions of claim 7, further comprising verifying a digital signature of the message using a public key corresponding to a private key of the first party.

9. The computer-readable medium of computer executable instructions of claim 7, wherein the first key of the asymmetric key pair is one of a 1024 bit or greater RSA key and a 160 bit or greater elliptic curve key.

10. A computer-readable medium having computer executable instructions for use in proving authorized ownership to a second party of data received from a first party comprising:
receiving from the first party a message including the data and a first key of an asymmetric key pair;
sending the data to the second party;
receiving an encrypted challenge from the second party; and
decrypting the encrypted challenge using the first key to create a response; and
sending the response to the second party; the response for use by the second party in confirming authorized ownership of the data.

11. The computer-readable medium of computer executable instructions of claim 10, wherein receiving from the first party the message comprises:
parsing the message into the data and key data; and
parsing the key data into an encrypted portion and a validity start time and a validity end time.

12. The computer-readable medium having computer executable instructions of claim 11, further comprising decrypting the encrypted portion using a form of a secret shared with the first party.

13. The computer-readable medium having computer executable instructions of claim 12, wherein the form of the shared secret is a key derivation of a hash of the shared secret.

14. The computer-readable medium having computer executable instructions of claim 13, wherein the key derivation is a PBKDF2 algorithm.

15. The computer-readable medium-having computer executable instructions of claim 13, wherein the hash is one of a SHA-256.

16. The computer-readable medium having computer executable instructions of claim 10, further comprising verifying a digital signature data of data in the message from the first party using an ECDSA-256 algorithm.
